(19) United States
(12) Patent Application Publication
(10) Pub. No.: US 2026/0064060 A1
(43) Pub. Date: Mar. 5, 2026

(54) DRIVE DEVICE AND IMAGE FORMING APPARATUS INCORPORATING THE DRIVE DEVICE

(71) Applicant: Hiroaki TAKAGI, Kanagawa (JP)

(72) Inventor: Hiroaki TAKAGI, Kanagawa (JP)

(73) Assignee: Ricoh Company, Ltd., Tokyo (JP)

(21) Appl. No.: 19/292,352

(22) Filed: Aug. 6, 2025

(30) Foreign Application Priority Data
Aug. 30, 2024 (JP) 2024-150221

(51) Int. Cl. G03G 15/00; G03G 21/16; G03G 21/20

(52) U.S. Cl. CPC G03G 15/5008; G03G 21/1633; G03G 21/1647; G03G 21/206; G03G 2221/1684

(57) ABSTRACT

A drive device includes a drawer, a drive motor, and a cover. The drawer is detachably attached to an image forming apparatus in a first direction. The drive motor is attached to the drawer. The cover covers the drive motor in a second direction different from the first direction.

### CROSS-REFERENCE TO RELATED APPLICATION

This patent application is based on and claims priority pursuant to 35 U.S.C. § 119(a) to Japanese Patent Application No. 2024-150221, filed on Aug. 30, 2024, in the Japan Patent Office, the entire disclosure of which is hereby incorporated by reference herein.

### BACKGROUND

### Technical Field

Embodiments of the present disclosure relate to a drive device and an image forming apparatus incorporating the drive device.

### Background

Typical drive devices are known that includes a drive motor attached to a drawer unit that is drawably attached to an image forming apparatus.

A drive device in the art is attached to a secondary transfer unit as a drawer unit to rotate a secondary transfer member by the drive motor.

However, it is likely that a dropping object that has dropped from, for example, an intermediate transfer unit disposed above the secondary transfer unit adheres to the drive motor.

### SUMMARY

Embodiments of the present disclosure described herein provide a novel drive device including a drawer, a drive motor, and a cover. The drawer is detachably attached to an image forming apparatus in a first direction. The drive motor is attached to the drawer. The cover covers the drive motor in a second direction different from the first direction.

Further, embodiments of the present disclosure described herein provide an image forming apparatus including the above-described drive device and an image former to form an image on a medium by the drive device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of a copier as an image forming apparatus according to an embodiment of the present disclosure;

FIG. 2 is a diagram illustrating a schematic configuration of one of image forming units;

FIG. 3 is a perspective view of a rear side of an image forming unit for forming a yellow toner image;

FIG. 4 is a perspective view of an image formation drive device;

FIG. 5 is a perspective view of a development drive unit and a cleaning drive unit of an image formation drive device;

FIG. 6 is a diagram illustrating conveyance of waste toner and discharged developer;

FIG. 7 is a diagram illustrating an intermediate transfer drive device and components near the intermediate transfer drive device;

FIG. 8 is a perspective view of an intermediate transfer drive device;

FIG. 9 is an exploded perspective view of an intermediate transfer drive device;

FIG. 10 is a cross sectional view of the intermediate transfer drive device, along line A-A in FIG. 7;

FIG. 11 is a diagram illustrating a case where an intermediate transfer motor cover is formed as a single unit of a resin molding product;

FIG. 12 is a perspective view of an intermediate transfer drive device where an intermediate transfer driving device in a state where a motor holding plate, an intermediate transfer drive motor and an intermediate transfer motor cover are removed;

FIG. 13 is a perspective view of a state where a motor holding plate is attached to an intermediate transfer housing;

FIG. 14 is a perspective view of a first cover;

FIG. 15 is a perspective view of a first cover positioned to an intermediate transfer motor;

FIG. 16 is a perspective view of an intermediate transfer drive device including an intermediate transfer motor cover formed as a single unit of a resin molding product;

FIG. 17 is a perspective view of an intermediate transfer drive device according to Modification 1 of the above embodiments of the present disclosure;

FIG. 18 is a diagram illustrating an intermediate transfer drive device and components near the intermediate transfer drive device according to Modification 2 of the above embodiments of the present disclosure; and

FIG. 19 is a perspective view of an intermediate transfer drive device according to Modification 2 of the above embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Hereinafter, descriptions are given of an image forming apparatus, for example a copier in the following embodiments, according to an embodiment of the present disclosure.

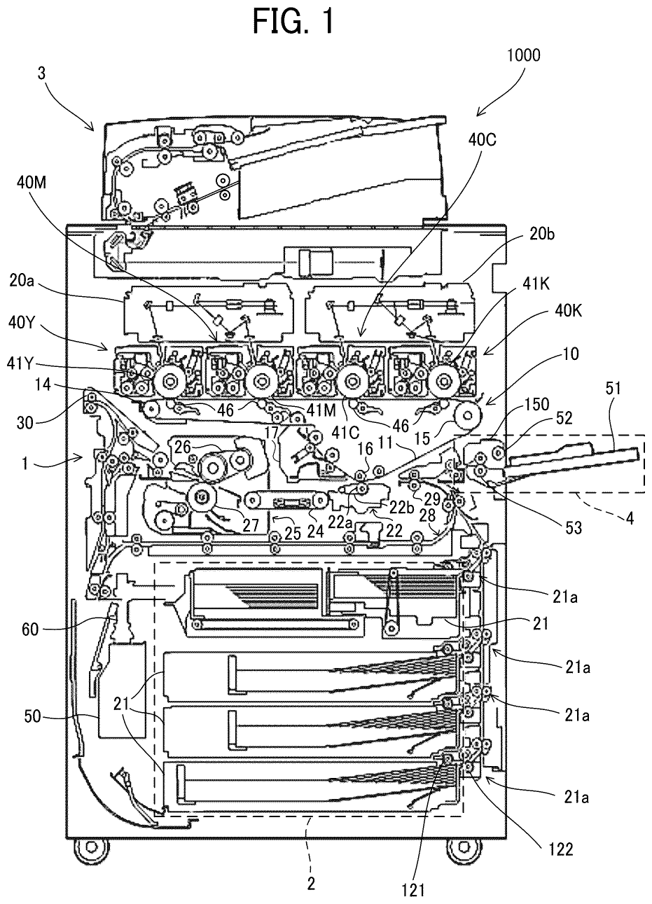

First, a description is given of the outline of a copier 1000, with reference to FIG. 1.

The copier 1000 has the function as what is called a digital color copier that digitizes image information obtained by scanning and reading an original document, and uses the image information to form an image. Further, the copier 1000 further has the function of a facsimile machine that sends/receives image data of an original document to/from a remote location, and the function of what is called a printer that prints, on a paper sheet, image information handled by a computer.

In FIG. 1, the copier 1000 forms an image on a recording sheet in an intermediate transfer system using an intermediate transfer belt 11, and is a tandem system electrophotographic apparatus that forms a toner image of each color with its dedicated image forming unit. A multistage sheet feeding device 2 is provided in the lowermost part of the copier 1000 in the vertical direction. The copier 1000 is provided an image forming device 1 above the sheet feeding device 2, and a scanner 3 is provided further above the image forming device 1. At each stage, the sheet feeding device 2 includes a sheet tray 21 and a sheet feed unit 21a. The sheet tray 21 contains a sheet bundle including recording sheets such as plain paper, OHP film sheet, and traced drawings, as recording sheets. The sheet feed unit 21a feeds a sheet of the sheet bundle contained in the sheet tray 21. The sheet feed unit 21a includes a pickup roller 121 and a sheet separation and conveyance unit 122. The pickup roller 121 picks up and feeds a recording sheet from the sheet tray 21. The sheet separation and conveyance unit 122 separates and feeds the recording sheet fed by the pickup roller 121.

An intermediate transfer unit 10 is arranged substantially in the middle of the image forming device 1. In the intermediate transfer unit 10, multiple rollers are arranged inside an endless loop of the intermediate transfer belt 11 so that the intermediate transfer belt 11 is stretched around the multiple rollers. The intermediate transfer belt 11 rotates (the surface of the intermediate transfer belt 11 moves) in a clockwise direction in FIG. 1. Four image forming units 40Y, 40M, 40C and 40K for forming toner images in yellow, magenta, cyan and black are arranged above the intermediate transfer belt 11 along a direction of movement of the surface of the intermediate transfer belt 11. Since the configurations of the four image forming units 40Y, 40M, 40C, and 40K, each functioning as an image forming device, are identical to each other except for the color of toner, the suffixes “Y”, “M”, “C”, and “K” indicating respective colors are omitted below as appropriate. Moreover, two optical writing units are provided above the four image forming units 40Y, 40M, 40C, and 40K. The two optical writing units are a first writing unit 20a and a second writing unit 20b, each functioning as a latent image writing unit.

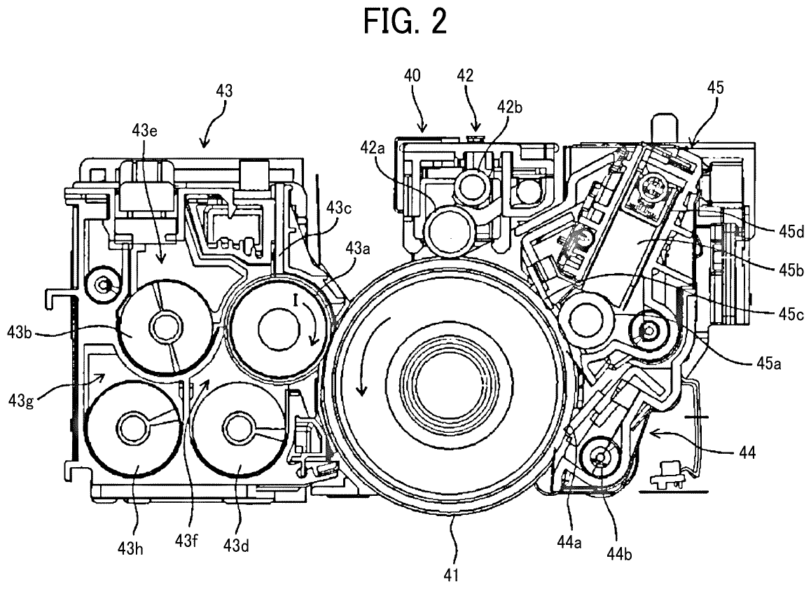

FIG. 2 is a diagram illustrating a schematic configuration of one of the image forming units 40Y, 40M, 40C and 40K.

The image forming units 40Y, 40M, 40C and 40K include a drum-shaped photoconductor 41 (i.e., photoconductors 41Y, 41M, 41C and 41K) that function as latent image bearers, respectively. The image forming unit 40 (i.e., the image forming units 40Y, 40M, 40C and 40K) supports various devices disposed around the photoconductor 41 (i.e., the photoconductors 41Y, 41M, 41C and 41K) as one unit by a common support. The image forming units 40Y, 40M, 40C and 40K are detachably attached to the housing of the image forming device 1.

Each photoconductor 41 is rotatably disposed in a counterclockwise direction in FIG. 2. A charging device 42, a developing device 43, and a photoconductor cleaning device 44, a lubricant applying device 45 are disposed around the photoconductor 41.

The charging device 42 mainly includes a charging roller 42a and a charging roller cleaner 42b. The charging roller 42a is arranged to contact the photoconductor 41. The charging roller cleaner 42b rotates in contact with the charging roller 42a. A charge bias is applied to the charging roller 42a to give electrical charge to the surface of the photoconductor 41, so that the surface of the photoconductor 41 is uniformly charged. The charging roller cleaner 42b removes adhered substances or foreign materials such as the toner adhered to the surface of the charging roller 42a.

The developing device 43 includes a developing roller 43a and a developer supply screw 43b. The developing roller 43a functions as a developer bearer to supply the toner to a latent image on the surface of the photoconductor 41 while moving the surface of the developing device 43 in a direction indicated by arrow I in FIG. 2, and develops the latent image. The developer supply screw 43b functions as a conveyance member to convey a developer from the far side to the near side in a direction orthogonal to the drawing sheet of FIG. 2 while supplying the developer to the developing roller 43a. The developer supply screw 43b includes a rotating shaft and a blade provided to the rotary shaft. The developer supply screw 43b conveys the developer in the axial direction while rotating.

The developing device 43 further includes a development doctor 43c, a developer collection screw 43d, a supply conveyance path 43e, a collection conveyance path 43f, a stirring conveyance path 43g, and a developer stirring screw 43h. The development doctor 43c is disposed downstream from an opposing portion between the developing roller 43a and the developer supply screw 43b in the developing roller surface movement direction. The development doctor 43c functions as a developer regulator to regulate the developer on the developing roller 43a to a thickness suitable for development. The developer collection screw 43d is disposed downstream from a development region in a moving direction of the surface of the developing roller 43a. The development region is an opposing region where the developing roller 43a and the photoconductor 41 face each other. The developer collection screw 43d collects the developer used for development of an image that has passed the development region. The developer collection screw 43d collects the developed developer from the developing roller 43a and conveys the collected developer in the same direction as the developer supply screw 43b conveys developer. The supply conveyance path 43e that accommodates the developer supply screw 43b is disposed on the side of the developing roller 43a. The collection conveyance path 43f is provided below the developing roller 43a in parallel with the developing roller 43a. The collection conveyance path 43f functions as a developer collection conveyance path that accommodates the developer collection screw 43d.

The stirring conveyance path 43g stirs and conveys the developer in a direction parallel with the collection conveyance path 43f below the supply conveyance path 43e. The stirring conveyance path 43g includes the developer stirring screw 43h that stirs the developer and, at the same time, conveys the developer toward the far side in FIG. 2, which is an opposite direction to the developer supply screw 43b.

The supply conveyance path 43e and the stirring conveyance path 43g are partitioned by a first partition wall. A partitioning part of the first partition wall between the supply conveyance path 43e and the stirring conveyance path 43g has an opening at both ends on the near side and the far side of FIG. 2. The supply conveyance path 43e communicates with the stirring conveyance path 43g via the opening. Even though both the supply conveyance path 43e and the collection conveyance path 43f are partitioned by the first partition wall, no opening is provided to a partitioning part of the first partition wall between the supply conveyance path 43e and the collection conveyance path 43f. Moreover, two conveyance paths, which are the stirring conveyance path 43g and the collection conveyance path 43f, are partitioned by a second partition wall. The second partition wall has an opening on the near side of FIG. 2. The stirring conveyance path 43g communicates with the collection conveyance path 43f via the opening.

The developer on the developing roller 43a is regulated to be thinner by the development doctor 43c. The developer is then conveyed to the development region, which is the opposing region facing an area between the photoconductor 41 and the developing roller 43a, to contribute to development. The developed developer is collected to the collection conveyance path 43f. The developer is then conveyed from the far side to the near side in the direction perpendicular to the drawing sheet of FIG. 2 to enter the stirring conveyance path 43g through the opening provided in the second partition wall. The toner is supplied into the stirring conveyance path 43g from a developer supply port provided at an upper part of the stirring conveyance path 43g in the vicinity of the opening of the second partition wall at the upstream end of the stirring conveyance path 43g in the developer conveyance direction.

In the supply conveyance path 43e that has received the supply of the developer from the stirring conveyance path 43g, the developer is conveyed by the developer supply screw 43b to the immediate vicinity of the extreme downstream side of the supply conveyance path 43e in the developer conveyance direction while being supplied to the developing roller 43a. There is a developer that was supplied to the developing roller 43a but not used for development and was conveyed to the immediate vicinity of the extreme downstream side of the supply conveyance path 43e in the developer conveyance direction. Such surplus developer is supplied to the stirring conveyance path 43g through a surplus opening formed in the first partition for the surplus developer.

The collected developer is sent from the developing roller 43a to the collection conveyance path 43f and conveyed by the developer collection screw 43d to the immediate vicinity of the extreme downstream side of the collection conveyance path 43f in the developer conveyance direction. The collected developer is then supplied to the stirring conveyance path 43g through a collection opening in the second partition wall. While stirring the surplus developer and the collected developer, the developer stirring screw 43h conveys the supplied surplus developer and the collected developer in the stirring conveyance path 43g to a position in the immediate vicinity of the extreme downstream side of the stirring conveyance path 43g in the developer conveyance direction and in the immediate vicinity of the extreme upstream side of the supply conveyance path 43e in the developer conveyance direction. The developer conveyed to this position enters the supply conveyance path 43e through a supply opening in the first partition wall.

In the stirring conveyance path 43g, the collected developer, the surplus developer, and the toner to be supplied from the developer supply ports are stirred and conveyed by the developer stirring screw 43h in the opposite direction to the developer conveyance direction in the collection conveyance path 43f and the supply conveyance path 43e. The stirred developer is then carried to the immediate vicinity of the extreme upstream side in the developer conveyance direction of the supply conveyance path 43e that communicates in the immediate vicinity of the extreme downstream side in the developer conveyance direction.

A toner concentration sensor is provided substantially immediately below the supply opening in the immediate vicinity of the extreme downstream side of the stirring conveyance path 43g in the developer conveyance direction. A toner supply control device is driven in response to an output from the toner concentration sensor. The toner is then supplied into the stirring conveyance path 43g.

The photoconductor cleaning device 44 includes a cleaning blade 44a and a discharging screw 44b. The cleaning blade 44a is a long elastic member extending in the axial direction of rotation of the photoconductor 41. A side (i.e., a contact side) that extends in a longitudinal direction of the cleaning blade 44a functions as an edge portion. The side (the edge portion) is pressed against the surface of the photoconductor 41 to separate and remove adhered substances such as transfer residual toner remaining on the surface of the photoconductor 41. The removed toner is ejected by the discharging screw 44b to the outside of the photoconductor cleaning device 44.

The lubricant applying device 45 includes a lubricant application brush 45a that functions as an application brush, a solid lubricant 45b, and a regulating blade 45c. The solid lubricant 45b is held by a bracket 45d and is pressurized by a pressing member toward the lubricant application brush 45a. The lubricant application brush 45a rotates in a direction to be rotated along with the rotational direction of the photoconductor 41. The lubricant application brush 45a scrapes the solid lubricant 45b to apply the lubricant onto the surface of the photoconductor 41. A side (i.e., a contact side) of the regulating blade 45c that extends in the longitudinal direction thereof functions as an edge portion. The side (the edge portion) is pressed against the surface of the photoconductor 41 so as to regulate the lubricant on the surface of the photoconductor 41.

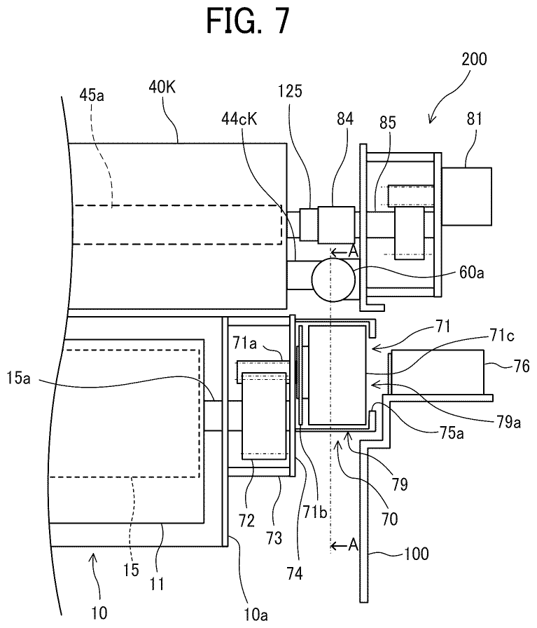

Back in FIG. 1, the intermediate transfer unit 10 includes the intermediate transfer belt 11, a belt cleaning device 17, and four primary transfer rollers 46. The intermediate transfer belt 11 is stretched (tensioned) by multiple rollers including a tension roller 14, a drive roller 15, and a secondary transfer counter roller 16. The intermediate transfer unit 10 further includes an intermediate transfer drive device 70 (see FIG. 7) as a drive device. Along with rotations of the drive roller 15 driven by the intermediate transfer drive device 70, the intermediate transfer belt 11 endlessly moves in the clockwise direction in FIG. 1.

The four primary transfer rollers 46 (i.e., the primary transfer rollers 46Y, 46M, 46C and 46K) are arranged to respectively contact an inner circumferential face side of the intermediate transfer belt 11. A primary transfer bias is applied by a power supply to the primary transfer rollers 46. Moreover, the intermediate transfer belt 11 is pressed by the primary transfer rollers 46 from the inner circumferential face toward the photoconductors 41 to form respective primary transfer nips. A primary transfer electric field is formed between the photoconductor 41 and the primary transfer roller 46 at each primary transfer nip due to the influence of the primary transfer bias. The toner image formed on the surface of the photoconductor 41 is primarily transferred onto the intermediate transfer belt 11 under the influence of the primary transfer electric field and the nip pressure.

Moreover, the intermediate transfer unit 10 includes a secondary transfer unit 22. The secondary transfer unit 22 is disposed below the intermediate transfer belt 11 and functions as a secondary transfer body. The secondary transfer unit 22 includes a secondary transfer roller 22a that contacts and presses the secondary transfer counter roller 16 via the intermediate transfer belt 11. Then, the secondary transfer roller 22a secondarily transfers the toner images on the intermediate transfer belt 11 collectively onto a recording sheet conveyed to the secondary transfer nip region formed between the secondary transfer roller 22a and the intermediate transfer belt 11.

The secondary transfer unit 22 includes a secondary transfer belt 22b that is stretched (tensioned) by the multiple rollers including the secondary transfer roller 22a. The secondary transfer unit 22 further includes a secondary transfer motor to drive and rotate one of the multiple rollers including the secondary transfer roller 22a. The secondary transfer unit 22 is drawable from the front side of the image forming device for maintenance such as a paper jam handling.

The belt cleaning device 17 is disposed downstream from the secondary transfer counter roller 16 in the direction of movement of the intermediate transfer belt 11. The belt cleaning device 17 removes residual toner remaining on the surface of the intermediate transfer belt 11 after the transfer of the images onto the recording sheet. The belt cleaning device 17 further includes a lubricant applying mechanism. The lubricant applying mechanism applies lubricant to the surface of the intermediate transfer belt 11.

A fixing device 25 is disposed downstream from the secondary transfer roller 22a in a sheet conveyance direction. The fixing device 25 fixes the toner image formed on the recording sheet, to the surface of the recording sheet. A fixing pressure roller 27 is pressed against an endless fixing belt 26. The recording sheet after transfer of the image is conveyed to the fixing device 25 by an endless conveyance belt 24 bridged across a pair of rollers. Moreover, a sheet reversing device 28 is disposed below the secondary transfer roller 22a to reverse a recording sheet upon formation of an image on both the front and back sides of the recording sheet.

A bypass sheet feeding device 4 is disposed on the right side of the image forming device 1 in FIG. 1. Furthermore, the bypass sheet feeding device 4 includes a bypass tray 51 and a bypass sheet feeding device 150. The bypass tray 51 loads a sheet to be fed by a bypass sheet feeding operation. The bypass sheet feeding device 150 feeds the recording sheet loaded on the bypass tray 51. The bypass sheet feeding device 150 includes a bypass pickup roller 52 and a bypass separation and conveyance unit 53. The bypass pickup roller 52 picks up and feeds a recording sheet from the bypass tray 51. The bypass separation and conveyance unit 53 separates and conveys the recording sheet fed from the bypass tray 51.

A waste toner collector 50 that collects waste toner discharged from the image forming units 40Y, 40M, 40C and 40K, the intermediate transfer unit 10, and the secondary transfer unit 22 is disposed on the left side of the sheet feeding device 2 in FIG. 1. Waste toner discharged from the image forming units 40Y, 40M, 40C and 40K, the intermediate transfer unit 10 and the secondary transfer unit 22 is conveyed to a waste toner collector 50 by a waste toner conveyor 60 disposed on the far side of the copier 1000, which will be described below.

When a color original document is copied with the copier 1000 including the above-described configurations, the scanner 3 reads an image of the color original document placed on an exposure glass. Moreover, the intermediate transfer belt 11 is rotated to form a toner image on each photoconductor 41 by typical image forming processes employed to the copier 1000. Then, the toner images formed on the photoconductors 41Y, 41M. 41C, and 41K are sequentially overlaid to be primarily transferred onto the intermediate transfer belt 11. Accordingly, a four-color composite toner image is formed on the intermediate transfer belt 11.

In parallel with the image forming operations of the four-color composite toner images being transferred onto the intermediate transfer belt 11, recording sheets are separated and fed, one by one, by a sheet feed unit 21a from a selected one of the sheet trays 21 of the sheet feeding device 2, and are conveyed toward a registration roller pair 29.

Instead of feeding recording sheets from the sheet tray 21, a recording sheet may be fed and conveyed by the bypass tray 51. In this case, the recording sheets on the bypass tray 51 are separated and fed one by one from the bypass sheet feeding device 150, toward the registration roller pair 29.

Then, the separated recording sheet is conveyed to the registration roller pair 29. The separated and conveyed recording sheet contacts a nip region of the registration roller pair 29. By so doing, the conveyance of the recording sheet is temporarily stopped, and the recording sheet is being held for standby. The registration roller pair 29 resumes the rotation at a proper timing in such a manner as to set the relative positions of the four-color composite toner image overlaid on the intermediate transfer belt 11 and the leading end of the recording sheet, to a given position. The registration roller pair 29 is rotated to convey the standby recording sheet again. Consequently, the secondary transfer roller 22a secondarily transfers the four-color composite toner image on the intermediate transfer belt 11, to the given position of the recording sheet. Thus, a full-color toner image is formed on the recording sheet.

The recording sheet with the full-color toner image is conveyed to the fixing device 25 that is disposed downstream from the secondary transfer roller 22a in the sheet conveyance path in the sheet conveyance direction. The fixing device 25 fixes the full-color toner image that has been secondarily transferred by the secondary transfer roller 22a, to the recording sheet. The recording sheet with the fixed full-color toner image is ejected by a sheet ejection roller 30 to the outside of the copier 1000. When a duplex printing mode is selected to form images on both sides of a recording sheet, when the recording sheet having the full-color toner image fixed on the first face is ejected from the fixing device 25, the recording sheet is conveyed to the sheet reversing device 28 instead of being conveyed to the sheet ejection roller 30. After the front and back sides of the recording sheet are reversed by the sheet reversing device 28, the recording sheet is conveyed again to the registration roller pair 29. The recording sheet passes through the secondary transfer nip region formed between the secondary transfer roller 22a and the intermediate transfer belt 11, and then through the fixing device 25, so that a full-color image is formed on a second face (the back side) of the recording sheet.

By opening the front cover of the image forming device 1, the image forming units 40Y, 40M, 40C and 40K, the intermediate transfer unit 10, the fixing device 25, a sheet conveyor as a sheet conveyance unit, and a sheet ejector as a sheet conveyance unit are exposed. The sheet conveyor includes, for example, the registration roller pair 29, the sheet reversing device 28, and a sheet conveyance driver having a conveyance motor to drive a conveyance roller such as the registration roller pair 29, so that the recording sheet conveyed from the sheet feeding device 2 is conveyed toward the secondary transfer roller 22a. The sheet ejector includes, for example, the sheet ejection roller 30, and a sheet ejection driver having an ejection motor to drive the sheet ejection roller 30, so that the recording sheet that has passed the fixing device 25 is to be ejected to the outside of the image forming device.

By opening a front cover of the image forming unit 1, the image forming units 40Y, 40M, 40C and 40K are pulled out from the front side of the image forming device 1 and are detachable from the image forming device 1. The fixing device 25 is also detachable from the front side of the image forming device 1. Each of the image forming units 40Y, 40M, 40C and 40K may be pulled out from the image forming device, so that the components of the image forming units (such as the photoconductor 41, the charging device 42, the developing device 43, and the photoconductor cleaning device 44) can be replaced with the image formation units being pulled out.

The sheet conveyor and the sheet ejector are disposed to be drawable from the image forming device 1. When a sheet jam occurs in the image forming device, the sheet conveyor and the sheet ejector are pulled out from the front side of the image forming device to remove the jammed sheet.

The intermediate transfer unit 10 is drawable from the front side of the image forming device 1. The secondary transfer unit 22 included in the intermediate transfer unit 10 can be separately drawable from the image forming device 1 at the time of maintenance such as a paper jam handling. As described above, in the present embodiment, the image forming units 40Y, 40M, 40C and 40K, the sheet conveyor, the sheet ejector, the fixing device 25, the intermediate transfer unit 10, and the secondary transfer unit 22 function as a drawer unit.

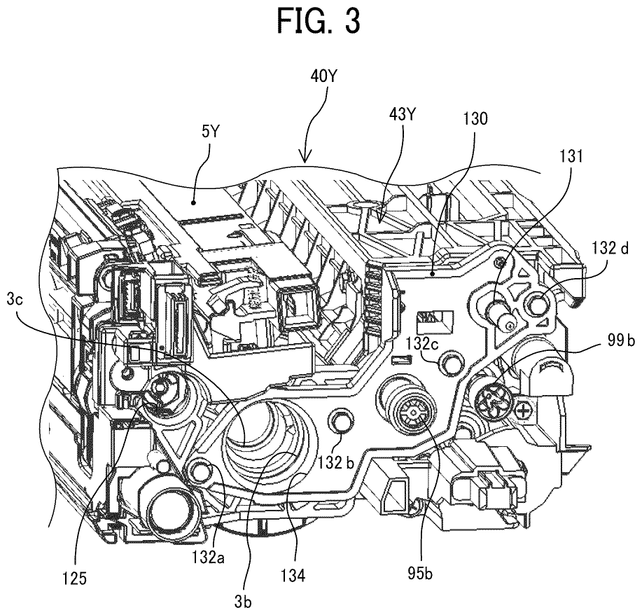

FIG. 3 is a perspective view of the rear side of the image forming unit 40Y for forming a yellow toner image.

As illustrated in FIG. 3, a positioning face plate 130 is attached to a side face on the rear side of the image forming unit 40Y. The positioning face plate 130 positions the photoconductor 41Y and the developing roller 43a such that a development gap between the photoconductor 41Y and the developing roller 43a is set to be a specified gap. Further, the positioning face plate 130 is screwed to the developing device 43 with screws 132a, 132b, 132c and 132d.

As illustrated in FIG. 3, the photoconductor 41Y includes a photoconductor driven side coupling 3b at the end portion on the rear side of the photoconductor 41Y. The photoconductor shaft is mounted on the image forming device 1. By inserting the photoconductor shaft of the photoconductor 41Y into a drum shaft opening 3c formed in the center of a flange of the photoconductor 41Y, the photoconductor 41Y is held by the photoconductor shaft.

To position the image forming unit 40Y to the image forming device 1, an image forming unit positioning pin 131 that passes through the positioning face plate 130 is inserted into an image forming unit positioning hole formed in the image forming device 1, and the photoconductor shaft mounted on the image forming device 1 is inserted into the photoconductor 41Y.

A development driven side coupling 95b and a screw driven side coupling 99b are disposed at the rear side of the image forming unit 40Y. The development driven side coupling 95b is mounted on the shaft of the developing roller 43a. The screw driven side coupling 99b is mounted on the shaft of the developer supply screw 43b. Further, a brush driven side coupling 125 is also disposed at the rear side of the image forming unit 40Y. The brush driven side coupling 125 is mounted on a brush shaft of the lubricant application brush 45a.

A gear is disposed at the end portion on the front side of the shaft of the developer supply screw 43b. A driving force is transmitted to the developer collection screw 43d and the developer stirring screw 43h via the gear, so as to drive and rotate the developer collection screw 43d and the developer stirring screw 43h. Another gear is disposed at the end portion on the front side of the brush shaft of the lubricant application brush 45a. A driving force is transmitted to the discharging screw 44b via the gear, so as to drive and rotate the discharging screw 44b.

The image forming units 40Y, 40M, 40C and 40K have respective configurations identical to each other except the colors of toners, and are occasionally described without suffixes indicating the toner colors, which are Y, M, C, and K. This occasional omission of suffixes is also applied to other units and components included in the copier 1000 according to an embodiment of this disclosure.

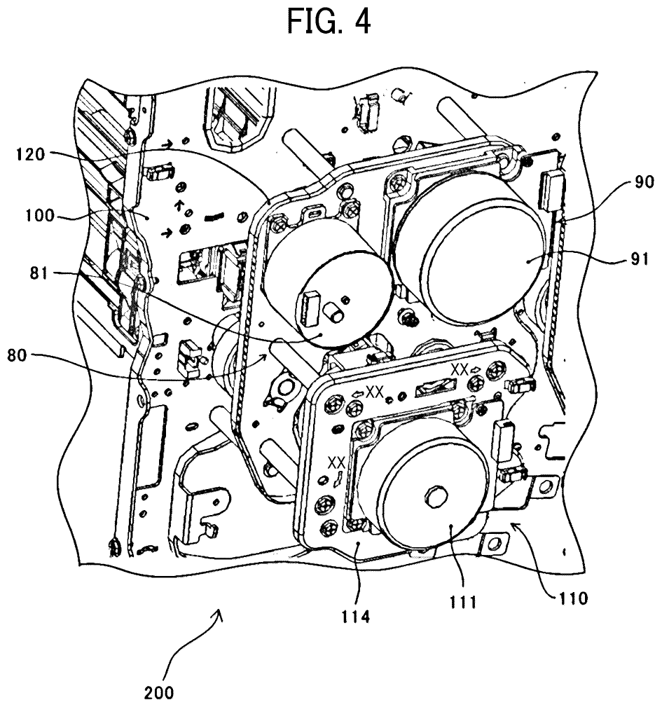

FIG. 4 is a perspective view of illustrating an image formation drive device 200 to drive the image forming unit 40 (i.e., the image forming units 40Y, 40M, 40C and 40K).

The image formation drive device 200 includes a photoconductor drive unit 110 including a photoconductor motor 111 that drives the photoconductor 41. The image formation drive device 200 includes a development drive unit 90 including a developing motor 91 that drives a rotary body in the developing device such as the developing roller 43a, the developer supply screw 43b, the developer collection screw 43d and the developer stirring screw 43h. The image formation drive device 200 further includes a cleaning drive unit 80 that includes a cleaning motor 81 to drive the lubricant application brush 45a and the discharging screw 44b. The developing motor 91 and the cleaning motor 81 are attached to a first motor attaching face plate 120. The first motor attaching face plate 120 is attached to the opposite side of a rear side plate 100, that is the opposite side to a side facing the image forming unit 40. The photoconductor motor 111 is mounted on a second motor attaching face plate 114. The second motor attaching face plate 114 is attached to the first motor attaching face plate 120.

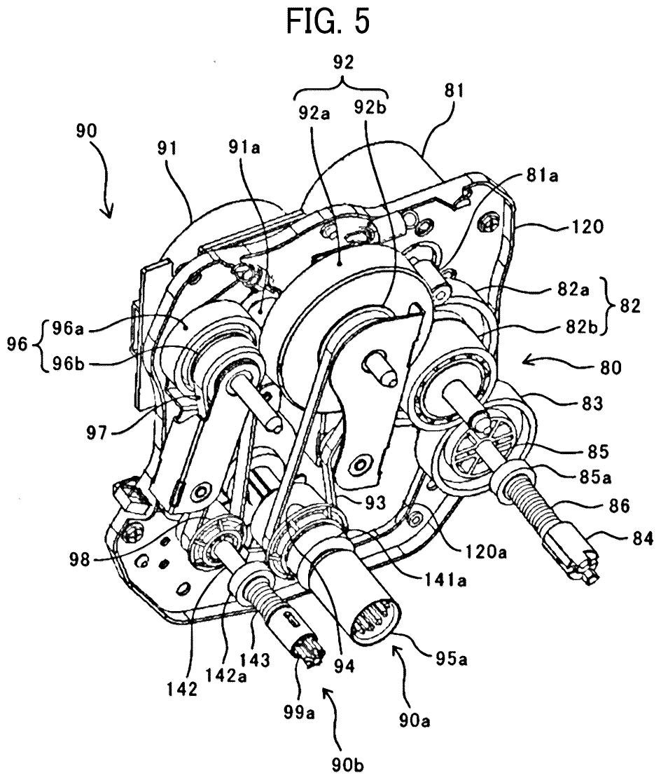

FIG. 5 is a perspective view of the development drive unit 90 and the cleaning drive unit 80 of the image formation drive device 200.

As illustrated in FIG. 5, the cleaning drive unit 80 includes a cleaning drive input gear unit 82, a cleaning drive output gear 83, a cleaning drive output shaft 85, a brush drive side coupling 84, and a coil spring 86. The cleaning drive input gear unit 82 includes a first gear 82a and a second gear 82b. The first gear 82a is meshed with a motor gear 81a of the cleaning motor 81. The second gear 82b is meshed with the cleaning drive output gear 83. The cleaning drive output gear 83 is mounted on the cleaning drive output shaft 85 so as to rotate together with the cleaning drive output shaft 85 as a single unit. The cleaning drive output shaft 85 is rotatably supported by the rear side plate 100 via a bearing 85a.

The brush drive side coupling 84 is mounted on the cleaning drive output shaft 85 to be slidable in the axial direction. The coil spring 86 is disposed between the brush drive side coupling 84 and the bearing 85a. The brush drive side coupling 84 is drivingly coupled with the brush driven side coupling 125 described above. By so doing, the driving force of the cleaning motor 81 is transmitted to the lubricant application brush 45a.

The development drive unit 90 includes a roller drive transmission path 90a and a screw drive transmission path 90b. The roller drive transmission path 90a transmits the driving force of the developing motor 91 to the developing roller 43a. The screw drive transmission path 90b transmits the driving force of the developing motor 91 to the developer supply screw 43b.

The roller drive transmission path 90a includes a roller drive input member 92, a roller timing belt 93, a roller drive output pulley 94, a roller drive output shaft 141, and a development drive side coupling 95a. The screw drive transmission path 90b includes a screw drive input member 96, a screw timing belt 97, a screw drive output pulley 98, a screw drive output shaft 142, a screw drive side coupling 99a, and a coil spring 143.

The roller drive input member 92 includes an internal gear 92a and a roller drive input pulley 92b. The internal gear 92a is meshed with the motor gear 91a of the developing motor 91. The roller timing belt 93 is wound around the roller drive input pulley 92b and the roller drive output pulley 94. The roller drive output pulley 94 is mounted on the roller drive output shaft 141 so as to rotate together with the roller drive output shaft 141 as a single unit. The roller drive output shaft 141 is rotatably supported by the rear side plate 100 via the bearing 141a. The development drive side coupling 95a is mounted on the leading end of the roller drive output shaft 141 so as to rotate together with the roller drive output shaft 141 as a single unit. The development drive side coupling 95a has a tubular portion (cylindrical portion) and internal teeth formed on the inner circumferential face of the tubular portion. The development driven side coupling 95b described above is inserted into the development drive side coupling 95a, so as to be drivingly coupled with the development drive side coupling 95a. Accordingly, the driving force of the developing motor 91 is transmitted to the developing roller 43a via a developing joint 95 including the development drive side coupling 95a and the development driven side coupling 95b.

The screw drive input member 96 includes an external gear 96a and a screw drive input pulley 96b. The external gear 96a is meshed with the motor gear 91a of the developing motor 91. The screw timing belt 97 is wound around the screw drive input pulley 96b and the screw drive output pulley 98. The screw drive output pulley 98 is mounted on the screw drive output shaft 142 so as to rotate together with the screw drive output shaft 142 as a single unit. The screw drive output shaft 142 is rotatably supported by the rear side plate 100 via a bearing 142a. The screw drive side coupling 99a is mounted on the leading end of the screw drive output shaft 142 to be slidable in the axial direction and rotatable together with the screw drive output shaft 142 as a single unit. The coil spring 143 is disposed between the screw drive side coupling 99a and the bearing 142a. The screw drive side coupling 99a is drivingly coupled with the screw driven side coupling 99b described above. Accordingly, the driving force of the developing motor 91 is transmitted to the developer supply screw 43b via a screw joint 99 including the screw drive side coupling 99a and the screw driven side coupling 99b.

A description is now given of conveyance of waste toner and discharged developer.

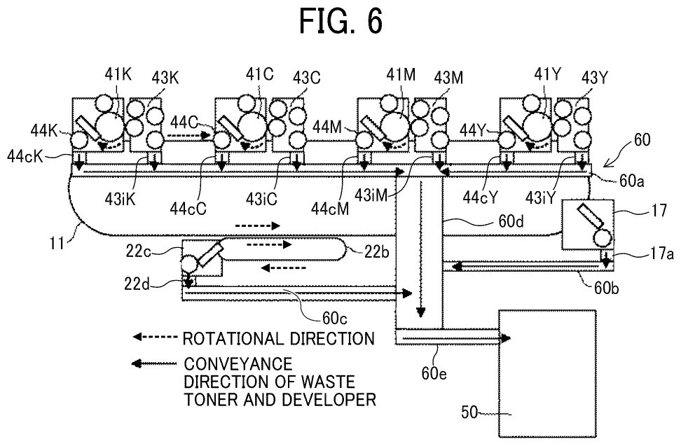

FIG. 6 is a diagram illustrating conveyance of waste toner and discharged developer. FIG. 6 is viewed from the rear side of the copier 1000.

The waste toner conveyor 60 is disposed on the rear side of the copier 1000. The waste toner conveyor 60 includes an image formation waste toner conveyance path 60a, an intermediate transfer waste toner conveyance path 60b, a secondary transfer waste toner conveyance path 60c, a dropping path 60d, and a final conveyance path 60e. The image formation waste toner conveyance path 60a, the intermediate transfer waste toner conveyance path 60b and the secondary transfer waste toner conveyance path 60c are coupled to the dropping path 60d, and the dropping path 60d is coupled to the final conveyance path 60e. The final conveyance path 60e is coupled to the waste toner collector 50.

The image formation waste toner conveyance path 60a conveys waste toner ejected from the photoconductor cleaning devices 44Y, 44M, 44C and 44K of the image forming units 40Y, 40M, 40C and 40K, respectively, and a developer ejected from the developing devices 43Y, 43M, 43C and 43K of the image forming units 40Y, 40M, 40C and 40K, respectively.

The image formation waste toner conveyance path 60a is coupled to image formation waste toner conveyance path 60a is connected to photoconductor cleaning discharging paths 44cY, 44cM, 44cC and 44cK and developer discharging paths 43iY, 43iM, 43iC and 43iK. The waste toner discharged from the photoconductor cleaning discharging paths 44cY, 44cM, 44cC and 44cK to the image formation waste toner conveyance path 60a is conveyed to the dropping path 60d by rotations of a conveyance screw disposed in the image formation waste toner conveyance path 60a. The developer discharged from the developer discharging paths 43iY, 43iM, 43iC and 43iK to the image formation waste toner conveyance path 60a is also conveyed to the dropping path 60d by rotations of a conveyance screw disposed in the image formation waste toner conveyance path 60a.

The intermediate transfer waste toner conveyance path 60b is coupled to a belt cleaning discharge path 17a of the belt cleaning device 17. The waste toner is discharged from the belt cleaning discharge path 17a. The waste toner discharged to the intermediate transfer waste toner conveyance path 60b is then conveyed toward the dropping path 60d by rotations of the conveyance screw disposed in the intermediate transfer waste toner conveyance path 60b.

The secondary transfer waste toner conveyance path 60c is coupled to a cleaning discharge path 22d of a secondary transfer belt cleaning device 22c to clean the surface of the secondary transfer belt 22b. The waste toner removed from the secondary transfer belt 22b is conveyed by the secondary transfer belt cleaning device 22c from the cleaning discharge path 22d. The waste toner discharged to the secondary transfer waste toner conveyance path 60c is then conveyed toward the dropping path 60d by rotations of the conveyance screw disposed in the secondary transfer waste toner conveyance path 60c.

The waste toner and developer conveyed to the dropping path 60d drops to the final conveyance path 60e, and is then conveyed to the waste toner collector 50 by the conveyance screw disposed in the final conveyance path 60e.

FIG. 7 is a diagram illustrating the intermediate transfer drive device 70 as a drive device to drive the intermediate transfer belt 11.

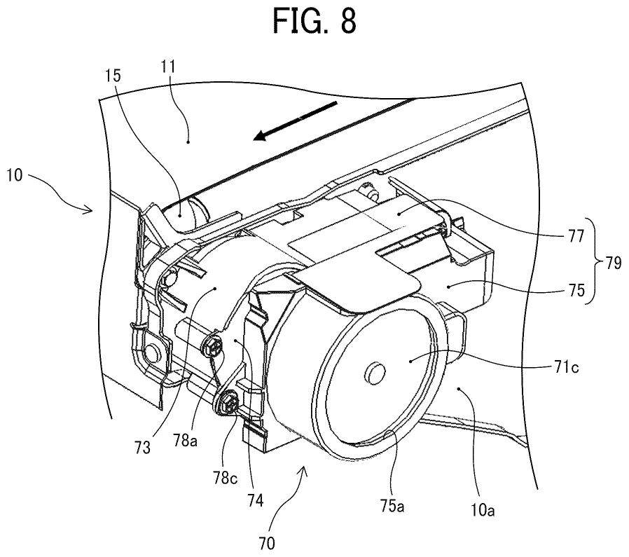

FIG. 8 is a perspective view of the intermediate transfer drive device 70.

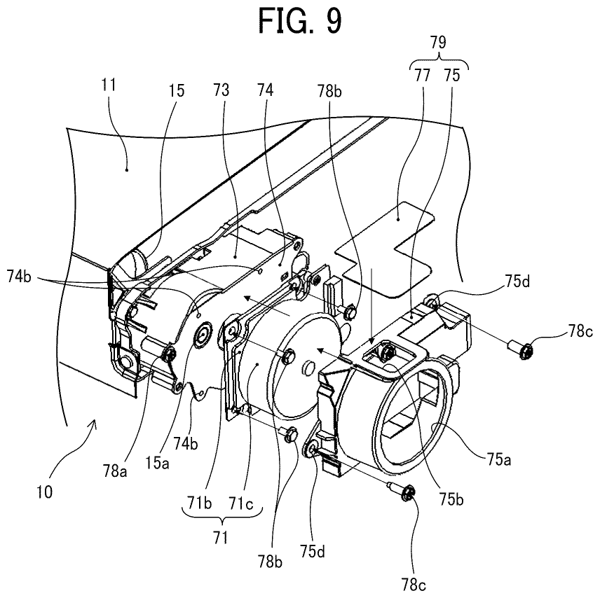

FIG. 9 is an exploded perspective view of the intermediate transfer drive device 70.

The intermediate transfer drive device 70 is attached to the transfer rear side plate 10a of the intermediate transfer unit 10 as a drawer unit, and the most part of the intermediate transfer drive device 70 is located at a portion closer to the center from the rear side plate 100 of the image forming device 1 (see FIG. 7). The intermediate transfer drive device 70 includes an intermediate transfer drive motor 71 as a drive motor, and an intermediate transfer drive gear 72. The intermediate transfer drive gear 72 is mounted on the shaft 15a of the drive roller 15 and is meshed with a gear portion formed on an output shaft 71a of the intermediate transfer drive motor 71.

The intermediate transfer drive motor 71 is an outer rotor type DC brushless motor and includes the output shaft 71a (motor shaft), a control board 71b, and a rotor 71c. The intermediate transfer drive motor 71 is screwed by screws 78b (see FIG. 9) to a motor holding metal plate 74 so that the output shaft 71a passes through the motor holding metal plate 74. The motor holding metal plate 74 is screwed by screws 78a (see FIGS. 8 and 9) to an intermediate transfer drive housing 73 attached to the transfer rear side plate 10a. The intermediate transfer drive housing 73 covers the intermediate transfer drive gear 72 and the output shaft 71a of the intermediate transfer drive motor 71.

The control board 71b and the rotor 71c of the intermediate transfer drive motor 71 are covered by an intermediate transfer motor cover 79 as a receiver. The intermediate transfer motor cover 79 includes a first cover 75 of a resin molding product and a second cover 77 of a sheet member (see FIGS. 8 and 9).

The first cover 75 has a cooling opening 75a that is open to expose a face of the rotor 71c, and the face is orthogonal to the axial direction of the drive roller (the front-and-back direction of the image forming apparatus). An intermediate transfer drive cooling fan 76 as an air blowing fan is disposed facing the cooling opening 75a (see FIG. 7). The air current generated by the intermediate transfer drive cooling fan 76 is taken from the cooling opening 75a into the internal space of the intermediate transfer motor cover 79 where the control board 71b and the rotor 71c are disposed. Due to such a configuration, the control board 71b and the rotor 71c are cooled by the cooling air. As a result, an increase in temperature of the intermediate transfer drive motor 71 can be prevented. Further, since the cooling opening 75a is disposed facing the intermediate transfer drive cooling fan 76, cooling air generated by the intermediate transfer drive cooling fan 76 can effectively be taken into the intermediate transfer motor cover 79, and an increase in temperature of the intermediate transfer drive motor 71.

As illustrated in FIG. 9, the first cover 75 has an opening 75b as an opposite opening in the upper part, and the second cover 77 of a sheet member covers the opening 75b. The second cover 77 is attached to the first cover 75 by a double-sided tape or adhesive. The first cover 75 is screwed to the intermediate transfer drive housing 73 by screws 78c.

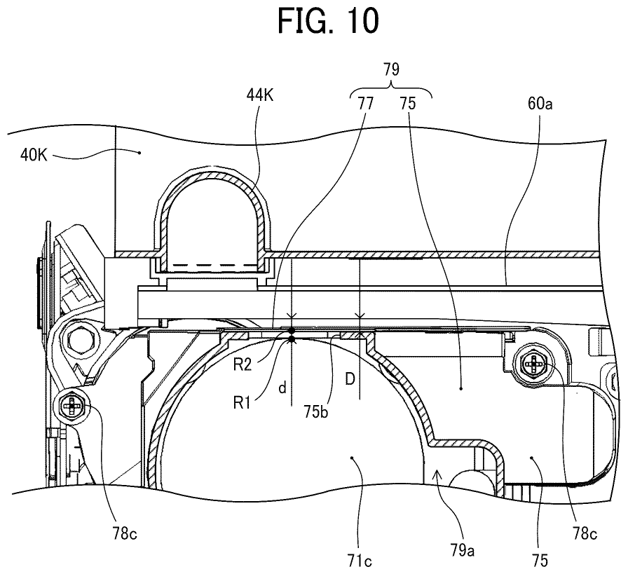

FIG. 10 is a cross sectional view of the intermediate transfer drive device 70, along line A-A in FIG. 7.

As illustrated in FIG. 10, in the present embodiment, the image formation waste toner conveyance path 60a as an adjacent member immediately above the intermediate transfer motor cover 79. In order to prevent interference between the intermediate transfer motor cover 79 and the image formation waste toner conveyance path 60a due to manufacturing errors or assembly errors, a given gap D needs to be provided between the intermediate transfer motor cover 79 and the image formation waste toner conveyance path 60a. Further, the rotor 71c of the intermediate transfer drive motor 71 disposed in the internal space of the intermediate transfer motor cover 79 rotates when the rotor 71c is driven. Due to such a configuration, the intermediate transfer motor cover 79 needs to provide a given gap between the intermediate transfer motor cover 79 and the rotor 71c so as not to contact the rotor 71c.

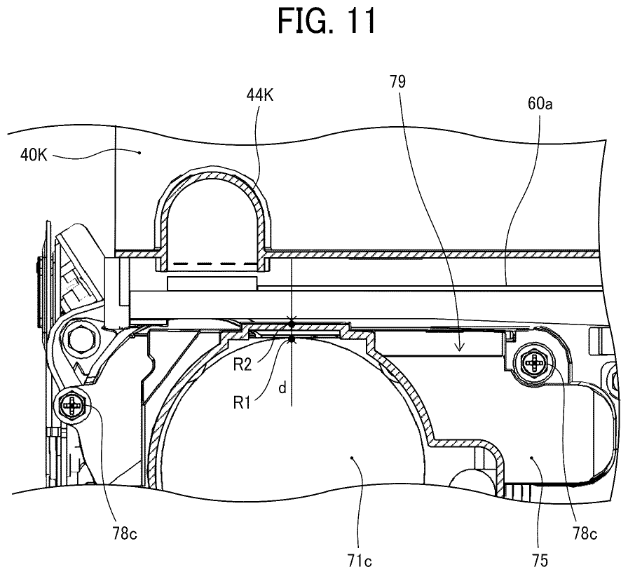

FIG. 11 is a cross-sectional view of the configuration of the intermediate transfer motor cover 79 formed as a single unit of a resin molding product.

In the configuration illustrated in FIG. 11, a length “d” from the top end R1 of the rotor 71c to the top end R2 of the intermediate transfer motor cover 79 disposed facing the image formation waste toner conveyance path 60a is the sum of the gap between the rotor 71c and the intermediate transfer motor cover 79 and the thickness of the resin molding product. As a result, the height of the intermediate transfer motor cover 79 increases, and the given gap D is not provided between the intermediate transfer motor cover 79 and the image formation waste toner conveyance path 60a. As a result, it is likely that the intermediate transfer motor cover 79 and the image formation waste toner conveyance path 60a interfere with each other due to manufacturing errors or assembly errors. In a case where the thickness of the opposing portion of the image formation waste toner conveyance path 60a with respect to the intermediate transfer motor cover 79 is reduced in order to reduce the height of the intermediate transfer motor cover 79, manufacturing errors such as sink marks may be generated, and the intermediate transfer motor cover 79 may not be manufactured accurately.

In contrast, in the present embodiment, the opening 75b is formed in the portion facing the image formation waste toner conveyance path 60a above the first cover 75 as illustrated in FIG. 10. Accordingly, even when the top end of the rotor 71c and the lower end of the opening 75b are positioned substantially at the same level in the vertical direction, a given gap can be formed between the rotor 71c and the first cover 75, and the height of the first cover 75 can be reduced.

Then, the second cover 77 of the sheet member whose thickness is relatively thin covers the opening 75b. Due to this configuration, the distance “d” from the top end R1 of the rotor 71c to the top end R2 of the intermediate transfer motor cover 79 may be substantially equal to the thickness of the first cover 75. Accordingly, a given gap is provided between the intermediate transfer motor cover 79 and the rotor 71c so that the intermediate transfer motor cover 79 does not contact the rotor 71c, and the height of the intermediate transfer motor cover 79 can be reduced. As a result, as illustrated in FIG. 10, a given gap D can be provided between the intermediate transfer motor cover 79 and the image formation waste toner conveyance path 60a, and interference between the intermediate transfer motor cover 79 and the image formation waste toner conveyance path 60a due to manufacturing errors or assembly errors can be prevented.

Although the top end of the rotor 71c is located at substantially the same position as the lower end of the opening 75b in the vertical direction in FIG. 10, the top end of the rotor 71c may be located inside the opening 75b.

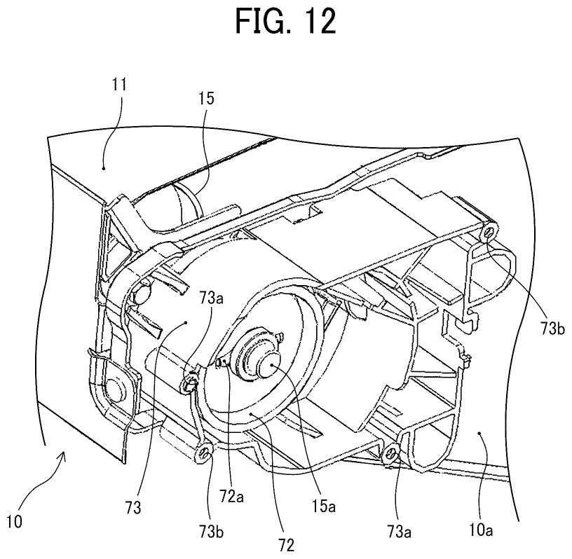

FIG. 12 is a perspective view of the intermediate transfer drive device 70 in a state where the motor holding metal plate 74, the intermediate transfer drive motor 71 and the intermediate transfer motor cover 79 are removed from the intermediate transfer drive device 70.

As illustrated in FIG. 12, parallel pins 72a pass through the rear end side of the shaft 15a of the drive roller 15, and the intermediate transfer drive gear 72 is engaged with the parallel pins 72a. The intermediate transfer drive housing 73 covers the intermediate transfer drive gear 72 and the output shaft 71a of the intermediate transfer drive motor 71, and includes two first internal threads 73a and two second internal threads 73b. The first internal threads 73a are to screw the motor holding metal plate 74. The second internal threads 73b are to screw the first cover 75.

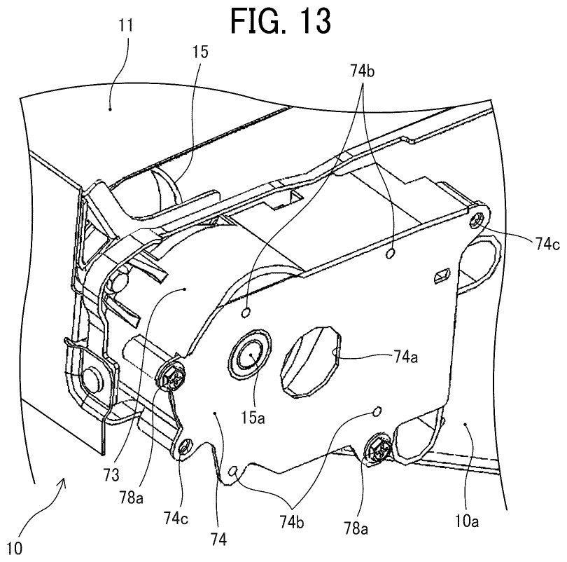

FIG. 13 is a perspective view of a state where the motor holding metal plate 74 is attached to the intermediate transfer drive housing 73.

As illustrated in FIG. 13, as the screws 78a are inserted into the first internal threads 73a, the motor holding metal plate 74 is screwed to the intermediate transfer drive housing 73.

A through hole 74a through which the output shaft 71a of the intermediate transfer drive motor 71 passes is formed at substantially the center of the motor holding metal plate 74. Internal threads 74b to screw the intermediate transfer drive motor 71 is formed at four portions around the through hole 74a.

The motor holding metal plate 74 supports the end portion of the rear side of the shaft 15a of the drive roller 15 via the bearings. As described above, the motor holding metal plate 74 that holds the intermediate transfer drive motor 71 supports the rear end side of the shaft 15a of the drive roller 15. By so doing, the accuracy in relative positions of the output shaft 71a of the intermediate transfer drive motor 71 and the shaft 15a of the drive roller 15 can be enhanced. Accordingly, the intermediate transfer drive gear 72 and the gear portion formed in the output shaft 71a of the intermediate transfer drive motor 71 can be meshed with each other accurately.

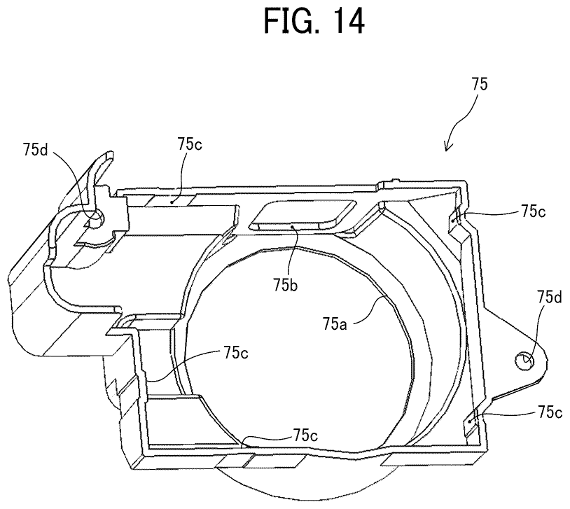

FIG. 14 is a perspective view of the first cover 75.

As illustrated in FIG. 14, screw through holes 75d are formed at two portions in the first cover 75, so that each of the screws 78c (see FIG. 9) passes through a corresponding one of the screw through holes 75d. Further, positioning projections 75c are formed in the top face, the bottom face and both side faces of the first cover 75.

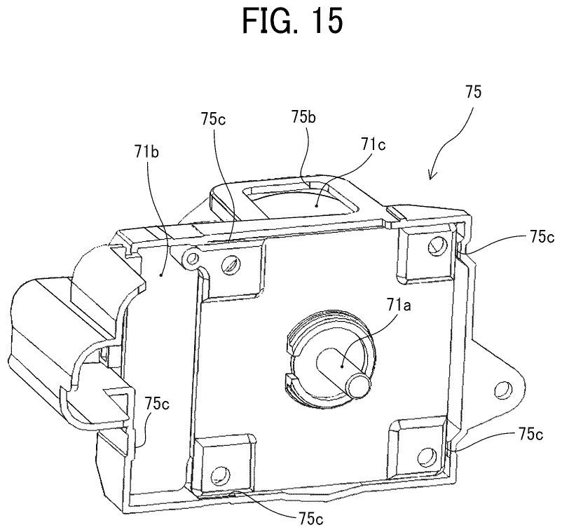

FIG. 15 is a perspective view of the first cover 75 positioned to the intermediate transfer drive motor 71.

As illustrated in FIG. 15, the positioning projections 75c contact the intermediate transfer drive motor 71. By so doing, the first cover 75 is positioned to the intermediate transfer drive motor 71. This configuration can prevent the first cover 75 from contacting the rotor 71c of the intermediate transfer drive motor 71, and can prevent the rotor 71c from sliding on the first cover 75 when the intermediate transfer drive motor 71 is driven. Further, the gap between the first cover 75 and the rotor 71c can be reduced (narrowed), the size of the first cover 75 is reduced, and the space saving of the image forming apparatus can be enhanced.

As illustrated in FIG. 7, in the present embodiment, the intermediate transfer drive motor 71 is located at a portion closer to the center of the image forming apparatus from the rear side plate 100 other than the rear end side of the rotor 71c. The coupling portion of the image formation waste toner conveyance path 60a and the photoconductor cleaning discharge path 44cK of the image forming unit 40K as a second drawer unit is provided above the control board 71b and the rotor 71c of the intermediate transfer drive motor 71. Further, the brush drive side coupling 84 that couples the brush shaft of the lubricant application brush 45a and the cleaning drive output shaft 85 is also provided above the intermediate transfer drive motor 71.

When the image forming unit 40K as a second drawer unit is drawn out to the front side, the coupling of the image formation waste toner conveyance path 60a and the photoconductor cleaning discharge path 44cK and the coupling of the brush shaft of the lubricant application brush 45a and the cleaning drive output shaft 85 are released. When the coupling of the image formation waste toner conveyance path 60a and the photoconductor cleaning discharge path 44cK is released, waste toner is likely to drop. Further, when the coupling of the brush shaft of the lubricant application brush 45a and the cleaning drive output shaft 85 is released, worn powder is likely to drop from the brush drive side coupling 84.

In the present embodiment, the control board 71b and the rotor 71c of the intermediate transfer drive motor 71 are covered by the intermediate transfer motor cover 79 as a receiver. Accordingly, when viewed from above, the control board 71b and the rotor 71c are covered and hidden by the intermediate transfer motor cover 79. As a result, the dropping object such as waste toner or worn powder dropping to the control board 71b or the rotor 71c of the intermediate transfer drive motor 71 when the image forming unit 40K is pulled out to the front side can be received by the intermediate transfer motor cover 79. Accordingly, this configuration can prevent adhesion of a dropping object such as waste toner or worn powder to the control board 71b and the rotor 71c of the intermediate transfer drive motor 71.

In the present embodiment, the output shaft 71a of the intermediate transfer drive motor 71 and the intermediate transfer drive gear 72 are covered by the intermediate transfer drive housing 73, and the output shaft 71a of the intermediate transfer drive motor 71 and the intermediate transfer drive gear 72 are hidden by the intermediate transfer drive housing 73 when viewed from above. Due to such configurations as described above, the dropping object such as waste toner or worn powder dropped from the intermediate transfer drive motor 71 or the intermediate transfer drive gear 72 can be received by the intermediate transfer drive housing 73. As a result, this configuration can present adhesion of a dropping object such as waste toner or worn powder to the output shaft 71a and the intermediate transfer drive gear 72.

Further, in the present embodiment, as illustrated in FIG. 7, the cooling opening 75a is located farther from the rear side plate 100 in the image forming device. Accordingly, this configuration can prevent waste toner or worn powder that drops when the image forming unit 40K is drawn out to the front side, from entering into the intermediate transfer motor cover 79 from the cooling opening 75a.

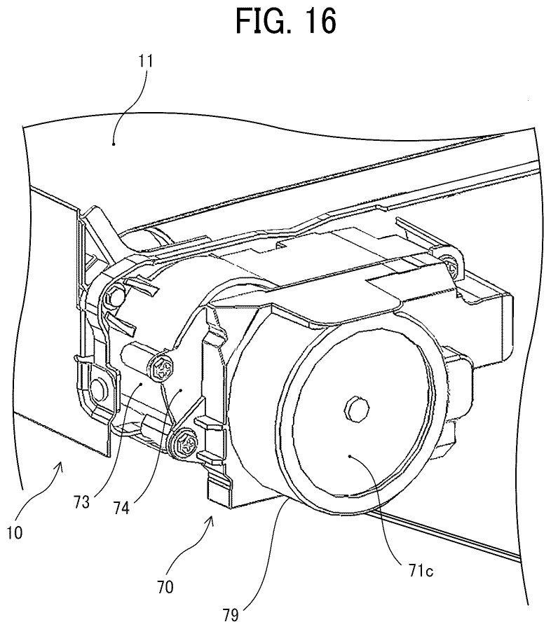

FIG. 16 is a perspective view of the intermediate transfer drive device 70 including the intermediate transfer motor cover 79 formed as a single unit of a resin molding product.

In the present embodiment, as described with reference to FIGS. 10 and 11, the intermediate transfer motor cover 79 is likely to interfere with the image formation waste toner conveyance path 60a. For this reason, the intermediate transfer motor cover 79 includes the first cover 75 of a resin molding product and the second cover 77 of a sheet member. However, when the image formation waste toner conveyance path 60a is provided at a position sufficiently separated from the intermediate transfer motor cover 79 and there is no chance that the above-described interference occurs, the intermediate transfer motor cover 79 may be formed in a resin molding product as a single unit as illustrated in FIG. 16.

### MODIFICATION 1

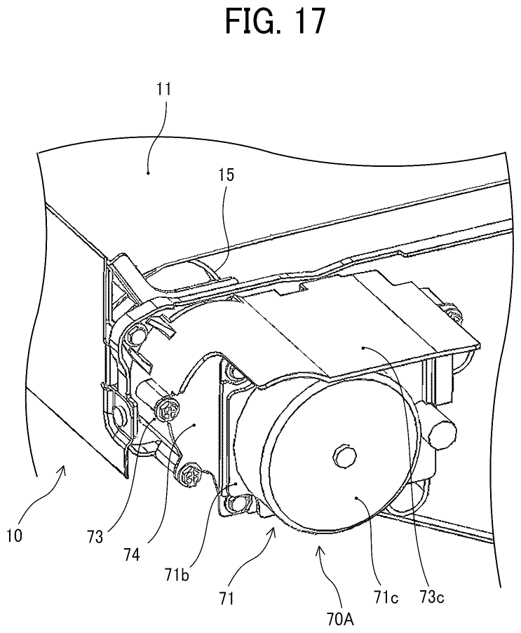

FIG. 17 is a perspective view of an intermediate transfer drive device 70A according to Modification 1 of the above embodiments of the present disclosure.

The intermediate transfer drive device 70A according to Modification 1 includes an eaves 73c to the intermediate transfer drive housing 73. When viewed from above, the control board 71b and the rotor 71c are hidden (covered) by the eaves 73c. As described above, the control board 71b and the rotor 71c are covered and hidden by the eaves 73c when viewed from above. As a result, when the image forming unit 40K is drawn out from the image forming apparatus, a dropping object such as waste toner or worn powder dropped to the control board 71b and the rotor 71c can be received by the eaves 73c. Accordingly, this configuration can prevent adhesion of a dropping object such as waste toner or worn powder to the control board 71b and the rotor 71c of the intermediate transfer drive motor 71.

In Modification 1, the intermediate transfer drive housing 73 functions as a receiver, and the output shaft 71a, the control board 71b and the rotor 71c of the intermediate transfer drive motor 71 are covered and hidden by the intermediate transfer drive housing 73 when viewed from above. In Modification 1, the intermediate transfer drive housing 73 as a receiver receives the whole dropping object to the intermediate transfer drive motor 71. In Modification 1, the intermediate transfer motor cover 79 can be removed, and the number of parts and components can be reduced. Accordingly, a reduction in cost of an intermediate transfer drive device 70A can be achieved.

### MODIFICATION 2

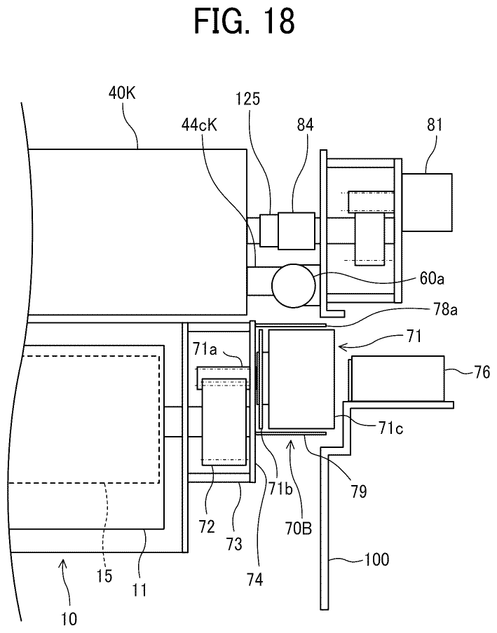

FIG. 18 is a diagram illustrating an intermediate transfer drive device 70B and components near the intermediate transfer drive device 70B according to Modification 2 of the above embodiments of the present disclosure.

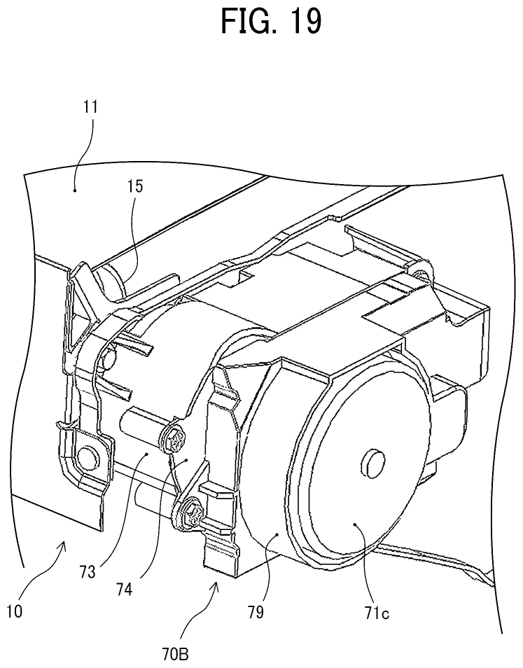

FIG. 19 is a perspective view of the intermediate transfer drive device 70B according to Modification 2 of the above embodiments of the present disclosure.

As illustrated in FIGS. 18 and 19, in the intermediate transfer drive device 70B in Modification 2, the intermediate transfer motor cover 79 covers the portion of the control board 71b and the rotor 71c of the intermediate transfer drive motor 71, where the portion is located at a portion closer to the center of the image forming apparatus from the rear side plate 100.

As illustrated in FIG. 18, the coupling portion of the image formation waste toner conveyance path 60a and the photoconductor cleaning discharge path 44cK of the image forming unit 40K is located at a portion closer to the center of the image forming apparatus from the rear side plate 100. Further, the brush drive side coupling 84 of the brush shaft of the lubricant application brush 45a and the cleaning drive output shaft 85 is located at a portion closer to the center of the image forming apparatus from the rear side plate 100. Due to such a configuration, when the image forming unit 40K is drawn out to the front side, waste toner or worn powder drops to the portion closer to the center from the rear side plate 100. As a result, as illustrated in FIGS. 18 and 19, in a case where the portion of the control board 71b and the rotor 71c of the intermediate transfer drive motor 71 located closer to the center from the rear side plate 100 is covered and hidden by the intermediate transfer motor cover 79, waste toner and worn powder dropped to the intermediate transfer drive motor 71 when the image forming unit 40K is drawn out to the front side can be received by the intermediate transfer motor cover 79. Accordingly, even if the portion of the rotor 71c outside from the rear side plate 100 is not covered by the intermediate transfer motor cover 79, adhesion of the dropping object such as waste toner or worn powder to the intermediate transfer drive motor 71 can be prevented.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

In the present embodiment, the present disclosure is applied to the intermediate transfer drive device 70 attached to the intermediate transfer unit 10, but the present disclosure may also be applied to a drive device to rotationally drive the secondary transfer belt 22b provided in the secondary transfer unit 22 as a drawer unit drawable from the image forming apparatus. However, a foreign material dropped from, for example, the intermediate transfer unit 10 disposed above the secondary transfer unit 22 can be prevented from adhering to the motor of the drive device of the secondary transfer unit 22.

Further, the present disclosure is also applicable to a drive device attached to a sheet conveyor or a sheet ejector, each of which functions as a sheet conveyance unit that is drawable from the image forming apparatus.

It is no need to receive all the dropping objects falling to the drive motor by the receiving member.

For example, when there is a portion where there is no problem even if the dropping object adheres to the drive motor, the dropping object dropping to the portion may not be received by the receiver.

The configurations according to the above-descried embodiments are examples, and embodiments of the present disclosure are not limited to the above-described examples. For example, the following aspects can achieve effects described below.

### ASPECT 1

In Aspect 1, a drive device such as an intermediate transfer drive device 70 includes a drive motor such as an intermediate transfer drive motor 71 and is attached to a drawer unit such as an intermediate transfer unit 10 that is drawable from an image forming apparatus. The drive device further includes a receiver such as an intermediate transfer motor cover 79 to receive a dropping object dropping to the drive motor.

According to this configuration, the dropping object that drops from a unit disposed above the drawer unit to the drive motor is received by the receiver. By so doing, the dropping object is prevented from adhering to the drive motor.

### ASPECT 2

In Aspect 2, in the drive device according to Aspect 1, the receiver such as the intermediate transfer motor cover 79 is disposed between the coupling portion of a member (corresponding to, for example, the brush drive side coupling 84 or the photoconductor cleaning discharging path 44c in the present embodiment) of a second drawer unit such as an image forming unit, which is drawably attached to the image forming apparatus and disposed above the drawer unit, and a member (corresponding to, for example, the brush driven side coupling 125 or the image formation waste toner conveyance path 60a in the present embodiment) of the image forming apparatus and the drive motor such as the intermediate transfer drive motor 71.

According to this configuration, the second drawer unit such as the image forming unit 40K described above is drawn from the image forming apparatus, so that the receiver such as the intermediate transfer motor cover 79 can receive the dropping object such as waste toner or worn powder that fell from the coupling portion when the coupling of the member (corresponding to, for example, the brush drive side coupling 84 or the photoconductor cleaning discharging path 44c in the present embodiment) of the second drawer unit and the member (corresponding to, for example, the brush driven side coupling 125 or the image formation waste toner conveyance path 60a in the present embodiment) of the image forming apparatus is released. Accordingly, the drive motor such as the intermediate transfer drive motor 71 can be prevented from the dropping object to adhere to the drive motor.

### ASPECT 3

In Aspect 3, in the drive device according to Aspect 1 or 2, a part of the drive motor such as the intermediate transfer drive motor 71 is located on an inner side from a side plate such as the rear side plate 100 of the image forming apparatus, and the receiver such as the intermediate transfer motor cover 79 shields (covers) the part located on the inner side from the side plate of the of the drive motor when viewed from above.

According to this configuration, as described in Modification 2, the coupling portion and a toner handling unit such as the image forming unit are disposed on the inner side from the side plate such as the rear side plate 100 of the image forming apparatus, and the dropping object such as toner may drop to the portion located on the inner side from the side plate of the drive motor.

Accordingly, as described in Modification 2, when viewed from above, the portion located on the inner side from the side plate of the drive motor is shielded (covered) by the receiver. By so doing, the dropping object such as toner can be received by the receiver, and adhesion of the dropping object to the drive motor can be prevented.

### ASPECT 4

In Aspect 4, in the drive device according to any one of Aspects 1 to 3, the drive motor such as the intermediate transfer drive motor 71 includes the output shaft 71a, the control board 71b, and the rotor 71c. The receiver such as the intermediate transfer motor cover 79 shields (covers) at least two of the output shaft 71a, the control board 71b, or the rotor 71c, when viewed from above.

According to this configuration, as described in the embodiments above, the dropping object that dropped toward at least two of the output shaft 71a, the control board 71b, or the rotor 71c from a unit disposed above the drive motor such as the intermediate transfer drive motor 71 can be received by the receiver, and adhesion of the dropping object to the drive motor can be prevented.

### ASPECT 5

In Aspect 5, in the drive device according to Aspect 4, the receiver such as the intermediate transfer motor cover 79 includes an internal space in which at least two of the output shaft 71a, the control board 71b, or the rotor 71c are disposed, and a shielding member that is the receiver including a cooling opening 75a through which cooling air is taken to the internal space.

According to this configuration, as described in the embodiments above, the member of the drive motor disposed in the internal space of the shielding member such as the intermediate transfer motor cover 79 can be cooled by cooling air taken from the cooling opening 75a of the receiver such as the intermediate transfer motor cover 79, and an increase in temperature of the drive motor can be prevented.

### ASPECT 6

In Aspect 6, in the drive device according to Aspect 5, the cooling opening 75a is disposed facing an air blowing fan such as the intermediate transfer drive cooling fan 76 to blow cooling air.

According to this configuration, the cooling air is efficiently taken into the internal space of the shielding member such as the intermediate transfer motor cover 79 from the cooling opening 75a, and an increase in temperature of the drive motor can be preferably prevented.

### ASPECT 7

In Aspect 7, in the drive device according to Aspect 5 or 6, a part of the drive motor such as the intermediate transfer drive motor 71 is located on an inner side from a side plate such as the rear side plate 100 of the image forming apparatus, and the cooling opening 75a is located on the outer side from the side plate.

According to this configuration, as described in the embodiments above, the dropping object form a unit disposed above the drive motor such as the intermediate transfer drive motor 71 can be prevented from entering the internal space of the shielding member such as the intermediate transfer motor cover 79 from the cooling opening 75a.

### ASPECT 8

In Aspect 8, in the drive device according to any one of Aspects 1 to 7, the receiver such as the intermediate transfer motor cover 79 includes a resin molding member such as the first cover 75, and a sheet member such as the second cover 77.

According to this configuration, as described in the embodiments above, the resin molding member needs to have a uniform thickness as much as possible in order to reduce manufacturing defects such as sink marks. Therefore, when the receiver such as the intermediate transfer motor cover 79 is formed in a single unit of a resin molding member, the gap of the receiver and a member such as the image formation waste toner conveyance path 60a disposed adjacent to the receiver may be narrowed. As a result, due to the assembly error, the receiver is likely to interfere with the member disposed adjacent to the receiver.

By forming the receiver such as the intermediate transfer motor cover 79 with the resin molding member such as the first cover 75 and the sheet member such as the second cover 77 and by forming the opposing portions of the receiver where with the sheet member, the sheet member is formed as the opposing portions of the receiver and a member (hereinafter, an adjacent member) such as the image formation waste toner conveyance path 60a disposed adjacent to the receiver, the thickness of the opposing portions can be reduced and the gap between the adjacent member and the receiver can be increased. Accordingly, due to the assembly error, the receiving member can be prevented from being interfered by the adjacent member.

### ASPECT 9

In Aspect 9, in the drive device according to Aspect 8, the resin molding member such as the first cover 75 includes an internal space in which at least the rotor 71c of the drive motor such as the intermediate transfer drive motor 71, and an opposite opening such as the opening 75b in the portion facing an adjacent part such as the image formation waste toner conveyance path 60a disposed adjacent to the receiver on an opposite wall facing the rotor 71c of the resin molding member with a given gap. The sheet member such as the second cover 77 covers the opposite opening of the resin molding member.

According to this configuration, as described in the embodiments above, a given gap is formed between the rotor 71c and the resin molding member such as the first cover 75, and a gap between the adjacent member such as the image formation waste toner conveyance path 60a and the receiver such as the intermediate transfer motor cover 79 can be formed. Accordingly, sliding to the resin molding member when the rotor 71c rotates can be prevented, and interference with the adjacent member can be prevented.

### ASPECT 10

In Aspect 10, in the drive device according to any one of Aspects 1 to 9, the drawer unit is the intermediate transfer unit 10, the secondary transfer unit 22, or a sheet conveyance unit such as the sheet conveyor or the sheet ejector.

### ASPECT 11

In Aspect 11, an image forming apparatus includes a drive device such as the intermediate transfer drive device 70, and a drawer unit such as the intermediate transfer unit 10 drawable from the image forming apparatus. In the image forming apparatus, the above-described drive device is the drive device according to any one of Aspects 1 to 10.

According to this configuration, adhesion of the foreign material to the drive motor of the drive device can be prevented.

### ASPECT 12

In Aspect 12, a drive device includes a drawer, a drive motor, and a cover. The drawer is detachably attached to an image forming apparatus in a first direction. The drive motor is attached to the drawer. The cover covers the drive motor in a second direction different from the first direction.

### ASPECT 13

In Aspect 13, the drive device according to Aspect 12 further includes another drawer and a coupling portion. Said another drawer is disposed above the drawer in the second direction, and is detachably attached to an image forming apparatus in the first direction. The coupling portion couples a part of said another drawer and a part of the image forming apparatus. The cover is disposed between the drive motor and the coupling portion.

### ASPECT 14

In Aspect 14, in the drive device according to Aspect 12 or 13, the drive motor has a part closer to a center of the image forming apparatus than a side plate of the image forming apparatus in the first direction. The cover covers the part of the drive motor from above the part of the drive motor in the second direction.

### ASPECT 15

In Aspect 15, in the drive device according to any one of Aspects 12 to 14, the drive motor includes an output shaft, a control board, and a rotor rotatable about the output shaft. The cover covers at least two of the output shaft, the control board, or the rotor from above the two of the drive motor in the second direction.

### ASPECT 16

In Aspect 16, the drive device according to Aspect 15 further includes another cover covering the drive motor in the first direction. Said another cover includes an internal space accommodating at least two of the output shaft, the control board, or the rotor, and a cooling opening to take cooling air into the internal space.

### ASPECT 17

In Aspect 17, the drive device according to Aspect 16 further includes a cooling fan facing the cooling opening of said another cover to blow the cooling air to the drive motor in the first direction.

### ASPECT 18

In Aspect 18, in the drive device according to Aspect 16 or 17, the drive motor has a part closer to a center of the image forming apparatus than a side plate of the image forming apparatus in the first direction. The cooling opening is located outside the side plate in the first direction.

### ASPECT 19

In Aspect 19, in the drive device according to any one of Aspects 12 to 18, the cover includes a sheet member above the drive motor in the second direction, and a resin molding member to cover the drive motor in the first direction.

### ASPECT 20

In Aspect 20, in the drive device according to Aspect 19, the resin molding member includes an internal space to place a rotor of the drive motor, and an opposite opening facing an adjacent part disposed adjacent to the cover on an opposite wall facing the rotor of the resin molding member with a given gap. The sheet member covers the opposite opening of the resin molding member.

### ASPECT 21

In Aspect 21, in the drive device according to any one of Aspects 12 to 20, the drawer includes at least one of an intermediate transfer unit or a secondary transfer unit.

### ASPECT 22

In Aspect 22, an image forming apparatus includes the drive device according to any one of Aspects 12 to 21, and an image former to form an image on a medium by the drive device.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A drive device comprising:
a drawer detachably attached to an image forming apparatus in a first direction;
a drive motor attached to the drawer; and
a cover to cover the drive motor in a second direction different from the first direction.

2. The drive device according to claim 1, further comprising:
another drawer:
disposed above the drawer in the second direction; and
detachably attached to an image forming apparatus in the first direction; and
a coupling portion coupling a part of said another drawer and a part of the image forming apparatus,
wherein the cover is disposed between the drive motor and the coupling portion.

3. The drive device according to claim 1,
wherein the drive motor has a part closer to a center of the image forming apparatus than a side plate of the image forming apparatus in the first direction, and
the cover covers the part of the drive motor from above the part of the drive motor in the second direction.

4. The drive device according to claim 1,
wherein the drive motor includes:
an output shaft;
a control board; and
a rotor rotatable about the output shaft, and
the cover covers at least two of the output shaft, the control board, or the rotor from above the two of the drive motor in the second direction.

5. The drive device according to claim 4, further comprising another cover covering the drive motor in the first direction,
wherein said another cover includes:
an internal space accommodating at least two of the output shaft, the control board, or the rotor; and
a cooling opening to take cooling air into the internal space.

6. The drive device according to claim 5, further comprising a cooling fan facing the cooling opening of said another cover to blow the cooling air to the drive motor in the first direction.

7. The drive device according to claim 5,
wherein the drive motor has a part closer to a center of the image forming apparatus than a side plate of the image forming apparatus in the first direction, and
the cooling opening is located outside the side plate in the first direction.

8. The drive device according to claim 1,
wherein the cover includes:
a sheet member above the drive motor in the second direction; and
a resin molding member to cover the drive motor in the first direction.

9. The drive device according to claim 8,
wherein the resin molding member includes:
an internal space to place a rotor of the drive motor; and
an opposite opening facing an adjacent part disposed adjacent to the cover on an opposite wall facing the rotor of the resin molding member with a given gap, and
the sheet member covers the opposite opening of the resin molding member.

10. The drive device according to claim 1,
wherein the drawer includes at least one of:
an intermediate transfer unit; or
a secondary transfer unit.

11. An image forming apparatus comprising:
the drive device according to claim 1; and
an image former to form an image on a medium by the drive device.
